(19) United States
(12) Patent Application Publication
(10) Pub. No.: US 2001/0042507 A1
(43) Pub. Date: Nov. 22, 2001

(54) Device for applying adhesives

(76) Inventor: Josef Rothen, Solingen (DE)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 09/860,058

(22) Filed: May 17, 2001

(30) Foreign Application Priority Data
May 18, 2000 (DE) 100 23 895.5

(51) Int. Cl. B05C 13/00

(52) U.S. Cl. 118/500

(57) ABSTRACT

A device for applying adhesives, in particular adhesives which have a tendency in particular to produce deposits even while they are being processed for adhesive bonding, has an application head with a slot nozzle of variable cross section and with a slide for setting the width of the nozzle slot. To keep the nozzle slot and the slide free from remains of adhesive, in particular adhesive coatings and deposits, the application head is provided in the region of the slide with a feed for a cleaning agent, which can be used to detach remains of adhesive and consequently remove them.

The invention relates to a device for applying adhesives with which there is the risk of agglutination, for example the formation of deposits and coatings of remains of adhesive, when said adhesive is being processed in the application device, and claims the priority of German patent application 100 23 895.5, to the content of which reference is made.

To change the width of the adhesive application, it is known in the case of application heads with slot nozzles to change the length of the slot nozzles with the aid of releasable interchangeable strips. However, this is a labor-intensive measure which causes not inconsiderable costs as a consequence of the necessary downtimes. This is so because, when the application width or the slot length is changed, first of all operation must be interrupted and then the existing interchangeable strip must be removed and replaced with a new strip of a larger or smaller length.

The use of slot nozzles with interchangeable strips is therefore very laborious, in particular in the case of small batch sizes or numbers of units, because they lead to correspondingly frequent changes.

Since very different slot lengths are required in practice, depending on the dimensions of the object to be adhesively bonded, a complete set of up to 40 interchangeable strips of different slot lengths belongs to each application head.

Adhesives are usually brought onto the surface to be adhesively bonded with the aid of an application head provided with one or more nozzles, for example a slot nozzle. Such application heads are heated in the case of thermoplastic adhesives, in order to give the adhesive a low viscosity, making it suitable for processing. The risk of the application head being soiled in the region of the nozzle by remains of adhesive depends specifically on the type of adhesive and, in particular, on the extent to which the adhesive already undergoes reactions in the application head or in the region of the application nozzle.

This risk is particularly great in the case of what are known as moisture-crosslinking adhesives, for example moisture-crosslinking polyurethane hot-melt adhesives, which in addition to the purely physical setting during hardening, crosslink under the influence of the moisture of the air and/or object on the basis of what is known as the urethane reaction. In this reaction, the influence of moisture turns the thermoplastic hot-melt adhesive into an unmeltable thermosetting material. In the process, the reactive constituents of the adhesive in the form of isocyanate groups react in a controlled manner with the moisture. This has the consequence that adhesives of this type have to be transported and stored in moisture-impermeable containers, from which they are transferred into the application device directly, i.e. with as little air contact as possible. However, complete air exclusion is not possible in the region of the application nozzles, with the result that undesired crosslinkage reactions are virtually unavoidable here. Such crosslinkage reactions may also occur if the processing temperature for thermoplastics is higher than is permissible.

To reduce the risk of deposits being formed as a result of hot-melt adhesive beginning to react, it is known to provide the adhesive-carrying parts of the applicator with a non-stick coating. Although, with a coating of this type, it is possible in an individual case to reduce the risk of agglutination, it cannot be eliminated, with the result that it is necessary from time to time to use freshly melted adhesive to force such deposits out of the nozzle head or to use a solvent to clean the nozzle head.

To avoid the removal and fitting of interchangeable strips when changing the application width, the invention proposes setting the length of the nozzle slot using a slide, with the aid of which it is possible in a simple way to increase or reduce the size of the nozzle slot.

However, such a slide entails the risk that, depending on the nature of the adhesive, the formation of deposits will occur, and consequently there will be blocking of the slide and/or a reduction in the cross section of the nozzle opening. To avoid this, a cleaning agent inlet may be located in the region of the slide and be used to feed a cleaning agent or solvent appropriate for the adhesive respectively being processed through to the slide and/or the slide guide. In the case of isocyanate-polyurethane hot-melt adhesives, alcohols, in particular mixtures of higher alcohols, may be used as the solvents which destroy or deactivate the cyanate groups.

The feeding in of the cleaning agent takes place in the manner of a lubricant feed, for example with the aid of a nipple which avoids flowing back of the cleaning fluid.

The solvent or cleaning agent distributes itself over the slide and the slide guide. Deposits and coatings made soft by the solvent go into solution or are automatically removed from the sliding surfaces by the slide when it is adjusted, and then go into solution. The solvent containing the dissolved adhesive may flow away through either the unused part of the nozzle slot or a special outlet.

The slide preferably has a triangular cross section and can then be mounted in a complementary guide which is angular in cross section on one side.

To avoid an accumulation of adhesive in the region of the nozzle slot, the slot edges may be offset with respect to one another counter to the direction of adhesive emergence. In this way, a kind of stepped slot is obtained, with the lower-lying slot edge preferably lying downstream of the projecting slot edge in the direction of movement of the adhesive material.

The nozzle slot may also be delimited by a releasable strip, which is preferably adjustable in height.

To make it possible for adhesive to be supplied even with very different slot widths, a plurality of adhesive lines open into a manifold arranged upstream of the nozzle slot; the mouths of said lines may be located in a longitudinal groove, which can be partially closed with the aid of the slide by the extent to which the slot width used becomes smaller.

The slide can be used to set the slot length in an infinitely variable manner, while the cleaning fluid ensures the serviceability of the slide if reactions of the adhesive, and consequently a formation of deposits, occur in the region of the slot.

The invention is explained in more detail below on the basis of an exemplary embodiment represented in the drawing, in which:

FIG. 1 shows a side view of an application head according to the invention;

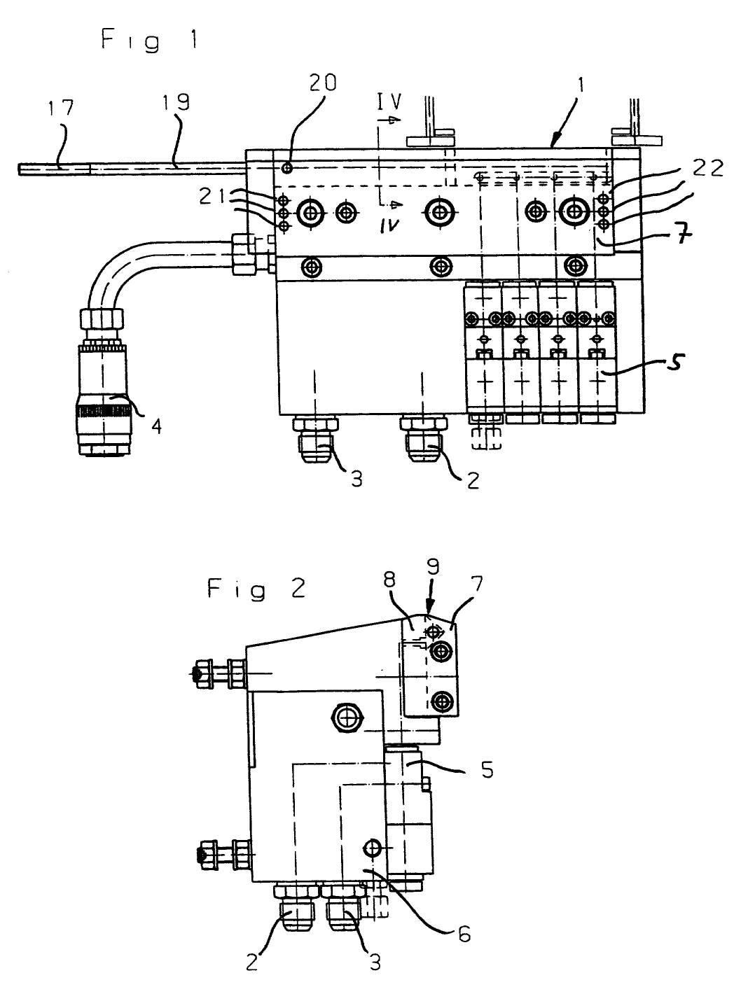

FIG. 2 shows a view of the end face of the application head of FIG. 1;

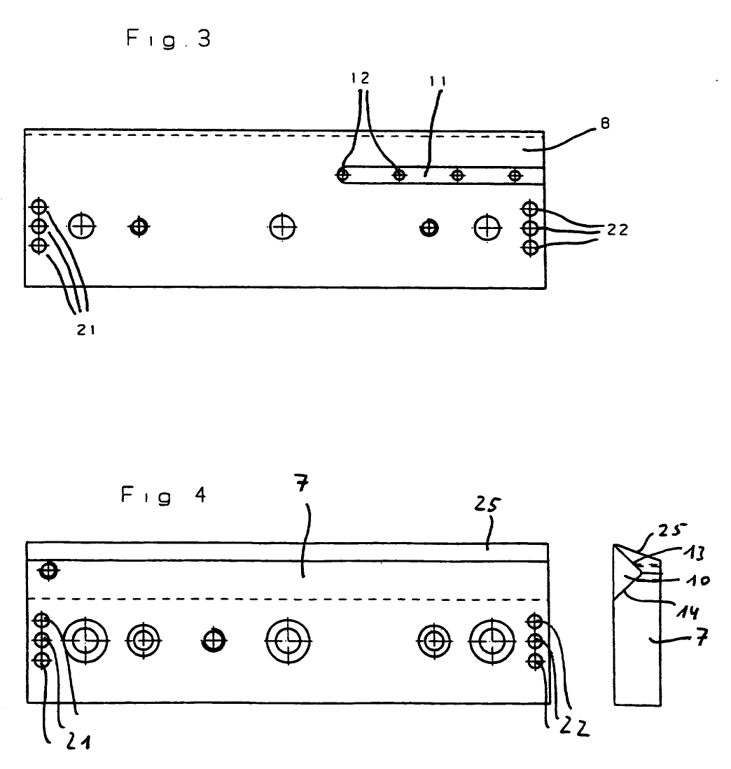

FIG. 3 shows the application strip of the interchangeable head of FIG. 1;

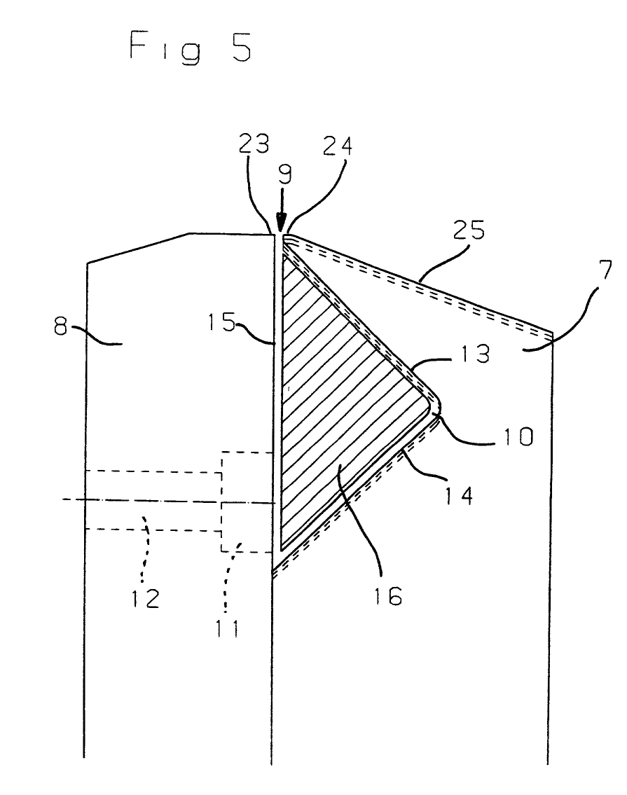

FIG. 4 shows a partial section along the line IV-IV in FIG. 1; and

FIG. 5 shows a cross section, similar to FIG. 4, of a stepped slot nozzle.

The application head 1 according to the invention is provided with a connection 2 for the adhesive supply and a connection 3 for the adhesive return and also an electrical line 4 for the internal heating of the application head.

The application head essentially comprises a switching module 5 and a circulation valve 6, through which adhesive constantly circulates, flowing in via the supply connection 2 and flowing away via the return connection 3, to prevent the formation of deposits.

In the upper part, the body of the application head 1 is provided with a releasable strip 7, which together with a counter-piece 8 forms a nozzle slot 9. In the interior of the application head there is behind the nozzle slot a manifold 10 with a groove 11, into which four adhesive supply lines 12 open. The manifold 10 has a cross section in the form of a right angle with guiding faces 13, 14 on the counter-piece 8 and a vertical guiding face 15 on the strip 7.

In the consequently triangular manifold 10, a slide 16 of the same cross section is arranged and guided with little play, being located at the end of a thrust rod 18 connected to a drive 17.

In the region behind the left-hand end position of the slide 16, a line 20, through which a cleaning agent can be fed to the manifold bounded by the guiding faces 13, 14, 15, opens into the manifold 10. This cleaning agent distributes itself in the part of the manifold located behind the slide 16 in the longitudinal direction and detaches or dissolves remains of adhesive located there.

Since the manifold is open on both sides of the slide, the adhesive-containing solvent can flow away via the nozzle slot. On the other hand, however, the nozzle slot may also be provided with a special outflow, which feeds the adhesive-containing solvent to a collecting container.

The application head is provided at both its head ends with in each case three bores, which are arranged one above the other and into which screw bolts 21, 22 engage. With these screw bolts, the strip 7 can be fastened at three different heights on the counter-piece 8. In this way it is possible to arrange the slot edges 23, 24 at the same height—as represented in FIG. 2—or at different heights—as represented in FIG. 5. An arrangement of the slot edges at different heights makes it possible for excess adhesive to flow away over the shoulder 25 of the strip 7 and consequently not accumulate in the region of the slot 9.

The slide 16 can be used to set the slot width as desired, corresponding to the required application width of, for example, between 3 and 83 mm. This takes place without the risk of deposits being formed by adhesive beginning to react, because the manifold in the unused part located to the left of the slide is filled with cleaning agent, a small amount of which also penetrates between the contact surfaces of the slide with the bounding or guiding faces 13, 14, 15 of the manifold 10 and, as a result, keeps the slide capable of sliding in the manner of a lubrication.

In the event of deposits forming in the part of the manifold 10 located upstream of the slide 16 in the direction of advancement, the slide can be moved into its right-hand end position and, in this way, the entire manifold can be made accessible for the solvent. When it moves in the manifold, the slide also cleans the guiding faces 13, 14, 15 in a mechanical way.

That which is claimed:

1. A device for applying adhesives, having
an application head,
a slot nozzle of variable cross section and
a slide for setting the width of the nozzle slot.

2. The device as claimed in claim 1, which comprises a cleaning agent connection in the region of the slide.

3. The device as claimed in claim 1, wherein the slide has a triangular cross section.

4. The device as claimed in claim 3, wherein the slide is mounted in a complementary triangular guide.

5. The device as claimed in claim 1, wherein the slot edges are offset with respect to one another counter to the direction of adhesive emergence.

6. The device as claimed in claim 1, wherein the nozzle slot is delimited by a strip.

7. The device as claimed in claim 6, wherein the strip is adjustable in height.

8. The device as claimed in claim 1, wherein the application head is provided with a plurality of bores arranged at different distances from the nozzle slot for fastening the strip by means of screw pins.

9. The device as claimed in claim 1, which comprises a plurality of adhesive lines opening into a manifold.

10. The device as claimed in claim 9, wherein the adhesive lines open into a groove.

11. The device as claimed in claim 1, wherein the slide is arranged at the free end of a thrust rod.
